(19) United States
(12) Patent Application Publication
(10) Pub. No.: US 2013/0083260 A1
(43) Pub. Date: Apr. 4, 2013

(54) LIGHT SOURCE DEVICE, DISPLAY APPARATUS AND ELECTRONIC EQUIPMENT

(71) Applicant: Masaru Minami, Kanagawa (JP)

(72) Inventor: Masaru Minami, Kanagawa (JP)

(73) Assignee: Sony Corporation, Tokyo (JP)

(21) Appl. No.: 13/608,108

(22) Filed: Sep. 10, 2012

(30) Foreign Application Priority Data
Sep. 29, 2011 (JP) 2011-214871

(51) Int. Cl. G02F 1/13357; F21V 8/00

(52) U.S. Cl. 349/15; 349/64; 362/608

(57) ABSTRACT

Provided is a light source device including a light guiding plate including a first internal reflection plane and a second internal reflection plane opposite to each other, a first light source irradiating an inside of the light guiding plate with first illumination light from its lateral side, and a diffusion member disposed opposite to the first internal reflection plane or the second internal reflection plane and diffusing incident light, wherein a plurality of transmission areas permitting the first illumination light to pass and to radiate toward an outside of the light guiding plate are provided on the first internal reflection plane or the second internal reflection plane, and the diffusion member is disposed opposite to the plurality of transmission areas and diffuses light having passed through the plurality of transmission areas.

### BACKGROUND

The present disclosure relates to a light source device, a display apparatus and electronic equipment enabling stereoscopic view in a parallax barrier method.

Stereoscopic display apparatuses in a parallax barrier method as one of stereoscopic display methods capable of stereoscopic view with naked eyes without mounting special glasses are known. FIG. 11 illustrates an example of a general configuration of a stereoscopic display apparatus in the parallax barrier method. This stereoscopic display apparatus is provided by disposing a parallax barrier 101 opposite to a front face of a two-dimensional display panel 102. The parallax barrier 101 has a general structure in which shielding parts 111 shielding display image light from the two-dimensional display panel 102 and stripe-shaped openings (slit parts) 112 transmitting the display image light are provided alternately in the horizontal direction.

An image based on three-dimensional image data is displayed on the two-dimensional display panel 102. For example, a plurality of parallax images with parallax information different from each other are prepared as the three-dimensional image data, and for example, a plurality of stripe-shaped divided images extending in the vertical direction are cut and formed from the individual parallax images. Then, by arranging the divided images alternately in the horizontal direction for each parallax image, a synthesized image including the plurality of parallax images with a stripe shape within one screen is generated, and the synthesized image is displayed on the two-dimensional display panel 102. In case of the parallax barrier method, the synthesized image displayed on the two-dimensional display panel 102 is observed through the parallax barrier 101. Appropriately setting a width of the displayed divided images, a slit width in the parallax barrier 101 and the like allows light rays of the parallax images different from each other to be incident independently on right and left eyes 10L and 10R of an observer through the slit parts 112 when the observer watches the stereoscopic display apparatus at and from a predetermined position and direction. Thus, a stereoscopic image can be perceived when the observer watches the stereoscopic display apparatus at and from the predetermined position and direction. Since it is strongly recommended to show the left eye 10L and the right eye 10R the different parallax images for realizing the stereoscopic view, at least two parallax images as a right eye image and a left eye image are strongly recommended to be provided. When using three or more parallax images, multi-eye view can be realized. The more the parallax images are, to the more extent the stereoscopic view can deal with change in viewpoint position of the observer. Namely, motion parallax can be realized.

In the example of the configuration in FIG. 11, the parallax barrier 101 is disposed on the front face of the two-dimensional display panel 102, whereas the parallax barrier 101 may be disposed on the rear face of the two-dimensional display panel 102, for example, in case of employing a transmissive liquid crystal display panel (refer to FIG. 10 of Japanese Patent No. 3565391 and FIG. 3 of Japanese Patent Application Publication No. 2007-187823). In this case, by disposing the parallax barrier 101 between the transmissive liquid crystal display panel and a backlight, stereoscopic display can be performed based on the principle similar to the example of the configuration in FIG. 11.

### SUMMARY

However, there is a problem in which, since the stereoscopic display apparatus in the parallax barrier method expects the parallax barrier, which is an exclusive component for three-dimensional display, the more number of components and more disposing space are expected compared with those of an ordinary display apparatus for two-dimensional display.

It is desirable to provide a light source device, a display apparatus and electronic equipment capable of realizing a function equivalent to a parallax barrier by using a light guiding plate.

According to one aspect of the present disclosure, there is provided a light source device including: a light guiding plate including a first internal reflection plane and a second internal reflection plane opposite to each other; a first light source irradiating the inside of the light guiding plate with first illumination light from its lateral side; and a diffusion member disposed opposite to the first internal reflection plane or the second internal reflection plane and diffusing incident light, wherein a plurality of transmission areas permitting the first illumination light to pass and to radiate toward the outside of the light guiding plate are provided on the first internal reflection plane or the second internal reflection plane. The diffusion member is disposed opposite to the plurality of transmission areas and diffuses light having passed through the plurality of transmission areas.

According to one aspect of the present disclosure, there is provided a display apparatus including: a display part performing image display; and a light source device emitting light for image display toward the display part, wherein the light source device is composed from the light source device according to the present disclosure as described above.

According to one aspect of the present disclosure, there is provided electronic equipment including the display apparatus according to the present disclosure.

In the light source device, the display apparatus or the electronic equipment according to the present disclosure, the first illumination light from the first light source passes through the transmission areas, and part or all of the light radiates toward the outside of the light guiding plate from the first internal reflection plane. The light thus having passed is diffused by the diffusion member. Thereby, the light guiding plate itself can have a function as a parallax barrier, and namely, can function as a parallax barrier in which the transmission areas are openings (slit parts) equivalently.

A light source device, a display apparatus or electronic equipment according to the present disclosure is provided with transmission areas on a first internal reflection plane or a second internal reflection plane of a light guiding plate, and light having passed through the transmission areas is diffused by a diffusion member. Therefore, the light guiding plate itself can function as a parallax barrier equivalently.

### BRIEF DESCRIPTION OF THE DRAWINGS

FIG. 1 is a cross-sectional view illustrating an example of a configuration of a display apparatus according to a first embodiment of the present disclosure in three-dimensional display and illustrating radiation of light rays from a light source device;

FIG. 2 is a cross-sectional view illustrating an example of a configuration of the display apparatus according to the first embodiment in two-dimensional display and illustrating radiation of light rays from the light source device;

FIG. 3A is a cross-sectional view illustrating a first exemplary configuration of a light guiding plate surface in the display apparatus illustrated in FIG. 1;

FIG. 3B is an explanatory drawing schematically illustrating reflection and transmission of light rays on the light guiding plate surface illustrated in FIG. 3A;

FIG. 4A is a cross-sectional view illustrating a second exemplary configuration of the light guiding plate surface in the display apparatus illustrated in FIG. 1;

FIG. 4B is an explanatory drawing schematically illustrating reflection and transmission of light rays on the light guiding plate surface illustrated in FIG. 4A;

FIG. 5 is a cross-sectional view illustrating an example of a configuration of a display apparatus according to a second embodiment in three-dimensional display along with radiation of light rays from a light source device;

FIG. 6 is a cross-sectional view illustrating an example of a configuration of the display apparatus according to the second embodiment in two-dimensional display along with radiation of light rays from the light source device;

FIG. 7 is a cross-sectional view illustrating one example of a configuration of a display apparatus according to a third embodiment along with radiation of light rays from the light source device when turning only a first light source to an ON (lit) state;

FIG. 8 is a cross-sectional view illustrating one example of a configuration of the display apparatus illustrated in FIG. 7 along with radiation of light rays from the light source device when turning only a second light source to an ON (lit) state;

FIG. 9A is a cross-sectional view illustrating a first exemplary configuration of a light guiding plate surface in the display apparatus illustrated in FIG. 7;

FIG. 9B is an explanatory drawing schematically illustrating transmission of light rays on the light guiding plate surface illustrated in FIG. 9A;

FIG. 10A is a cross-sectional view illustrating a second exemplary configuration of the light guiding plate surface in the display apparatus illustrated in FIG. 7;

FIG. 10B is an explanatory drawing schematically illustrating transmission of light rays on the light guiding plate surface illustrated in FIG. 10A;

FIG. 11 is a general example of a configuration of a stereoscopic display apparatus in a parallax barrier method; and

FIG. 12 is an appearance view illustrating one example of electronic equipment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### First Embodiment

### Entire Configuration of Display Apparatus

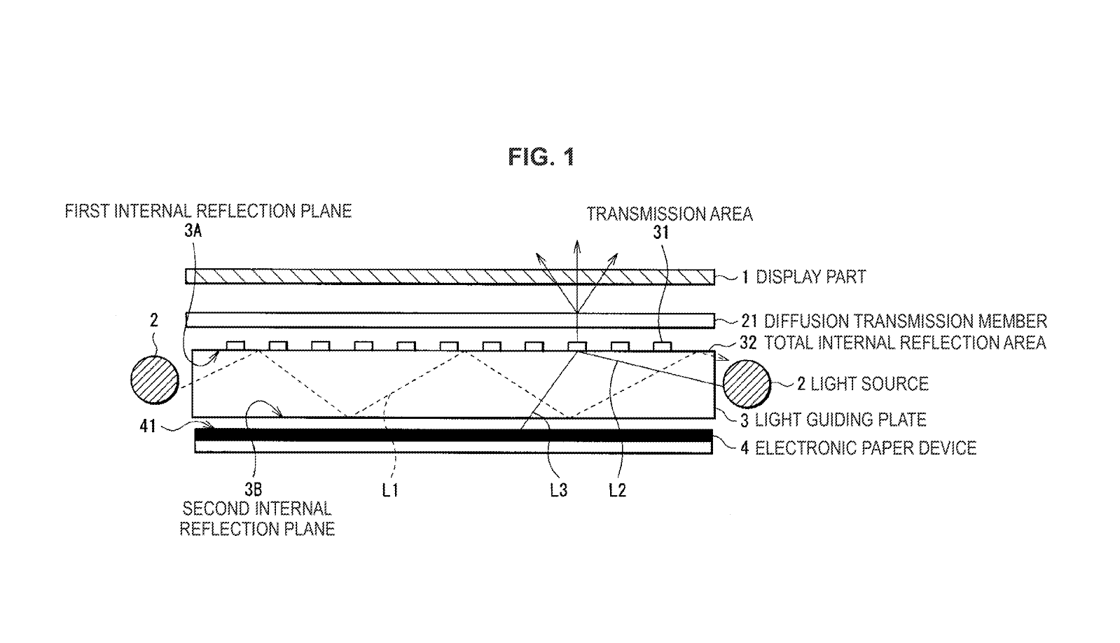

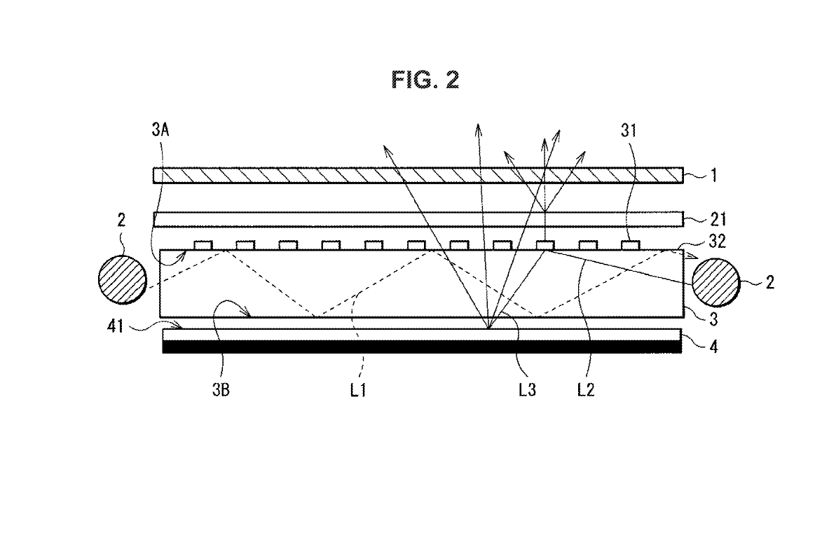

FIG. 1 and FIG. 2 illustrate one example of a configuration of a display apparatus according to a first embodiment of the present disclosure. This display apparatus includes a display part 1 performing image display, and a light source device disposed on a rear face side of the display part 1 and emitting light for image display toward the display part 1. The light source device includes a light source 2, a light guiding plate 3, an electronic paper device 4 and a diffusion transmission member 21.

This display apparatus is selectively switchable between a two-dimensional (2D) display mode over the entire screen and a three-dimensional (3D) display mode over the entire screen arbitrarily. FIG. 1 illustrates a configuration in the three-dimensional display mode and FIG. 2 illustrates a configuration in the two-dimensional display mode. FIG. 1 and FIG. 2 also illustrate radiation of light rays from the light source device in the respective display modes.

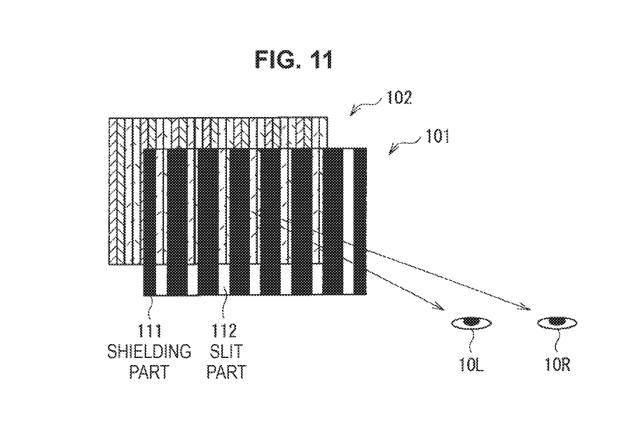

The display part 1 employs a transmissive two-dimensional display panel such as a transmissive liquid crystal display panel, for example, and includes a plurality of pixels constituted of pixels for R (red), pixels for G (green) and pixels for B (blue), for example, and the plurality of pixels are arranged in a matrix shape. The display part 1 performs two-dimensional image display by modulating light from the light source device for each pixel in accordance with image data. The display part 1 performs selectively switching between an image based on three-dimensional image data and an image based on two-dimensional image data to display arbitrarily. In addition, the three-dimensional image data is data including a plurality of parallax images corresponding to a plurality of viewing angle directions in three-dimensional display, for example, and when performing two-eye three-dimensional display, is parallax image data for right eye display and for left eye display, for example. When performing display in the three-dimensional display mode, a synthesized image, for example, including a plurality of parallax images in a stripe shape within one screen similarly to the stereoscopic display apparatus in the existing parallax barrier method illustrated in FIG. 11 is generated and displayed.

The electronic paper device 4 is disposed on a side on which a second internal reflection plane 3B is formed with respect to the light guiding plate 3. The electronic paper device 4 is an optical device selectively switchable of action with respect to an incident light ray between two states of a light absorption state and a scattering reflection state. The electronic paper device 4 is composed of a particle movement-type display employing an electrophoresis technique or a liquid powder technique, for example. The particle movement-type display performs black display and white display by dispersing black particles, for example, positively charged and white particles, for example, negatively charged between a pair of opposing substrates and moving the particles in response to voltage applied between the substrates. Specifically, in the electrophoresis technique, the particles are dispersed in a solution, and in the liquid powder technique, the particles are dispersed in gas. The above-mentioned light absorption state corresponds to a state of entire screen black display of a display plane 41 of the electronic paper device 4 as illustrated in FIG. 1, and the scattering reflection state corresponds to a state of entire screen white display of the display plane 41 of the electronic paper device 4 as illustrated in FIG. 2. When displaying an image based on three-dimensional image data on the display part 1 (switching to the three-dimensional display mode), the electronic paper device 4 switches action with respect to an incident light ray to the light absorption state. Moreover, when displaying an image based on two-dimensional image data on the display part 1 (switching to the two-dimensional display mode), the electronic paper device 4 switches action with respect to an incident light ray to the scattering reflection state.

The light source 2 includes a fluorescent lamp such as a CCFL (Cold Cathode Fluorescent Lamp) or an LED (Light Emitting Diode), for example. At least one light source 2 is disposed on a lateral side of the light guiding plate 3 and irradiates the inside of the light guiding plate 3 from the lateral side with illumination light (light ray L1). FIG. 1 and FIG. 2 illustrate an example of a configuration in which light sources 2 are disposed on both lateral sides of the light guiding plate 3.

The light guiding plate 3 is composed from a transparent plastic plate made of acrylic resin or the like, for example. The light guiding plate 3 includes a first internal reflection plane 3A opposingly disposed on the display part 1 side and the second internal reflection plane 3B opposingly disposed on the electronic paper device 4 side. The light guiding plate 3 guides light rays from the light source 2 in the lateral face direction due to total internal reflection between the first internal reflection plane 3A and second internal reflection plane 3B.

The second internal reflection plane 3B has undergone specular working over its entirety, and allows a light ray L1 incident by an incident angle θ1 that meets the total internal reflection condition to undergo total internal reflection. The first internal reflection plane 3A includes transmission areas 31 and total internal reflection areas 32. In the first internal reflection plane 3A, the total internal reflection areas 32 and transmission areas 31 are provided alternately, for example, in a stripe shape so as to be a structure corresponding to a parallax barrier. Namely, as described later, they are formed into a structure in which the transmission areas 31 function as openings (slit parts) as a parallax barrier and the total internal reflection areas 32 function as shielding parts in the three-dimensional display mode.

The total internal reflection area 32 allows a light ray L1 incident by an incident angle θ1 that meets the total internal reflection condition to undergo total internal reflection (allows a light ray L1 incident by an incident angle θ1 greater than a predetermined critical angle α to undergo total internal reflection). The transmission area 31 radiates at least part of a light ray incident by an angle corresponding to an incident angle θ1 that meets a predetermined total internal reflection condition in the total internal reflection areas 32 out of incident light rays L2 to the outside (radiates at least part of a light ray incident by an angle corresponding to an incident angle θ1 greater than the predetermined critical angle α to the outside). Moreover, in the transmission area 31, a light ray L3 which is the remaining part undergoes internal reflection out of the incident light rays L2.

In addition, supposing that a refractive index of the light guiding plate 3 is represented by n1 and a refractive index of a medium outside the light guiding plate 3 (air layer) is represented by n0 (<n1), the critical angle α is represented by the following formula, where α and θ1 are angles with respect to the normal vector of the light guiding plate surface. The incident angle θ1 that meets the total internal reflection condition meets the condition θ1>α.

sin α=n0/n1

The diffusion transmission member 21 is a diffusion member with a function of diffusing incident light and is sheet-like or plate-like. The diffusion transmission member 21 is disposed opposite to the first internal reflection plane 3A. In addition, the diffusion transmission member 21 is enough to be disposed opposite to portions at least corresponding to the transmission areas 31. The diffusion transmission member 21 diffuses and transmits light having passed through the transmission areas 31.

### [Specific Example of Configuration of Transmission Areas 31]

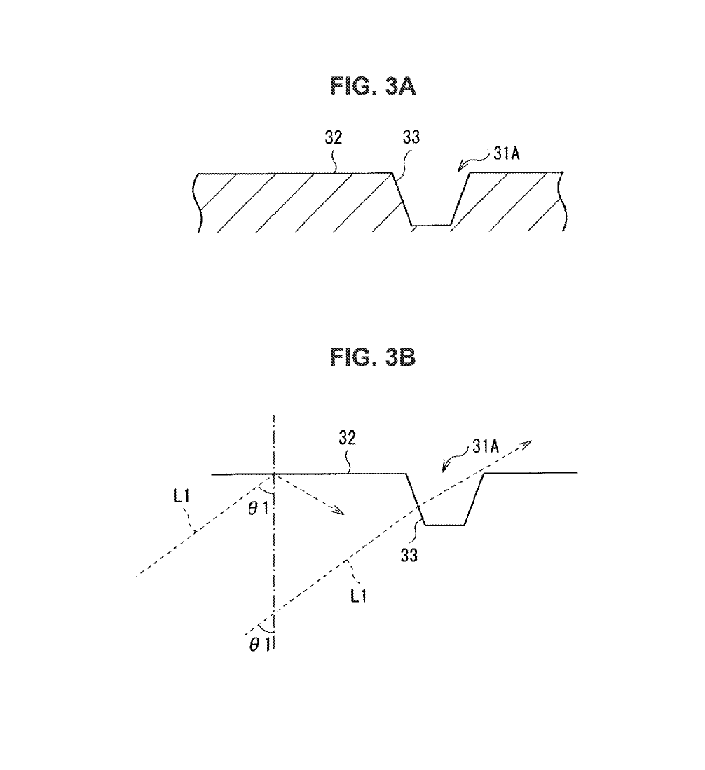

FIG. 3A illustrates a first exemplary configuration of a surface of the light guiding plate 3. FIG. 3B schematically illustrates reflection and transmission of light rays on the surface of the light guiding plate 3 illustrated in FIG. 3A. This first exemplary configuration is an exemplary configuration in which the transmission area 31 is formed into a transmission area 31A with a concave shape with respect to the total internal reflection areas 32. Such a concave shape can be formed by performing specular working on the surface of the light guiding plate 3 and, after that, performing laser machining on the portion corresponding to the transmission area 31A, for example. In case of the transmission area 31A with such a concave shape, at least part of light rays incident by an angle corresponding to the incident angle θ1 that meets the predetermined total internal reflection condition in the total internal reflection areas 32 out of incident light rays do not meet the total internal reflection condition in a lateral part 33 of the concave shape, and pass as they are to radiate to the outside.

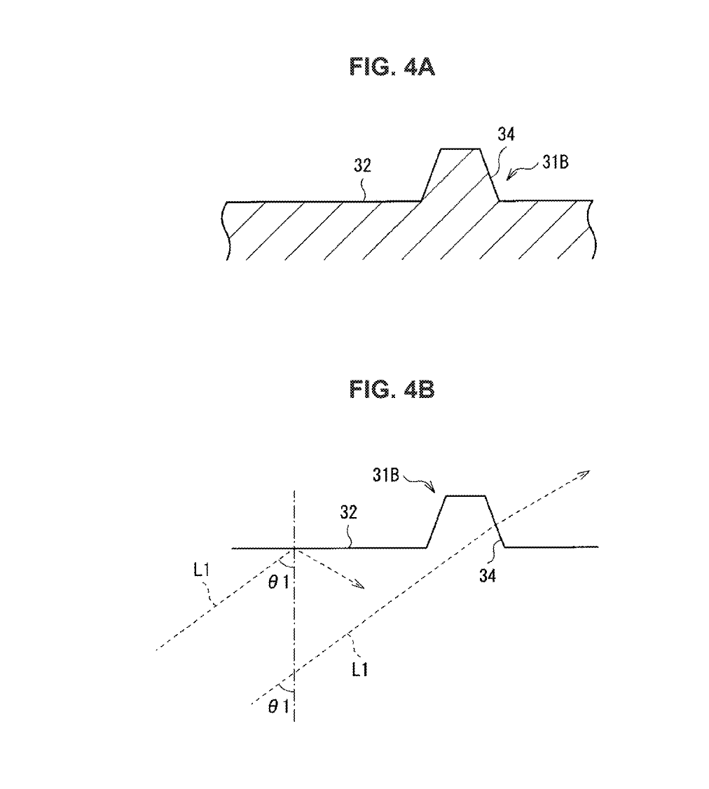

FIG. 4A illustrates a second exemplary configuration of a surface of the light guiding plate 3. FIG. 4B schematically illustrates reflection and transmission of light rays on the surface of the light guiding plate 3 illustrated in FIG. 4A. This second exemplary configuration is an exemplary configuration in which the transmission area 31 is formed into a transmission area 31B with a convex shape with respect to the total internal reflection areas 32. Such a convex shape can be formed by molding the surface of the light guiding plate 3 using a die, for example. In this case, portions corresponding to the total internal reflection areas 32 undergo specular working with the surface of the die. In case of the transmission area 31B with such a convex shape, at least part of light rays incident by an angle corresponding to the incident angle θ1 that meets the predetermined total internal reflection condition in the total internal reflection areas 32 out of incident light rays do not meet the total internal reflection condition in a lateral part 34 of the convex shape, and pass as they are to radiate to the outside.

### [Operation of Display Apparatus]

When performing display in the three-dimensional display mode for this display apparatus (FIG. 1), the display part 1 performs image display based on three-dimensional image data, and the display plane 41 of the electronic paper device 4 is switched to the state of entire screen black display (light absorption state). Under these conditions, a light ray from the light source 2 undergoes total internal reflection repeatedly between the total internal reflection areas 32 of the first internal reflection plane 3A and the second internal reflection plane 3B in the light guiding plate 3, and thereby, is guided from one lateral side on which the light source 2 is disposed to the opposing other lateral side to radiate from the other lateral side. Meanwhile, out of light rays L2 incident on the transmission area 31 of the first internal reflection plane 3A in the light guiding plate 3, at least part of light rays that do not meet the total internal reflection condition pass through the transmission area 31 as they are to radiate to the outside. Furthermore, the light ray having passed through the transmission area 31 is diffused by the diffusion transmission member 21 to radiate to the display part 1 side. Moreover, in the transmission area 31, a light ray L3 which is the remaining part undergoes internal reflection, and the light ray L3 is incident on the display plane 41 of the electronic paper device 4 through the second internal reflection plane 3B of the light guiding plate 3. Herein, since the display plane 41 of the electronic paper device 4 is switched to the state of entire screen black display, the light ray L3 is absorbed on the display plane 41. As a result, light rays radiate only from the transmission areas 31 in the first internal reflection plane 3A of the light guiding plate 3. Namely, the surface of the light guiding plate 3 can function equivalently as a parallax barrier in which the transmission areas 31 are openings (slit parts) and the total internal reflection areas 32 are shielding parts. Thereby, the three-dimensional display is performed similarly to a parallax barrier method for which a parallax barrier is disposed on the rear face side of the display part 1.

On the other hand, when performing display in the two-dimensional display mode (FIG. 2), the display part 1 performs image display based on two-dimensional image data, and the display plane 41 of the electronic paper device 4 is switched to the state of entire screen white display (scattering reflection state). Under these conditions, a light ray from the light source 2 undergoes total internal reflection repeatedly between the total internal reflection areas 32 of the first internal reflection plane 3A and the second internal reflection plane 3B in the light guiding plate 3, and thereby, is guided from one lateral side on which the light source 2 is disposed to the opposing other lateral side to radiate from the other lateral side. Meanwhile, out of light rays L2 incident on the transmission area 31 of the first internal reflection plane 3A in the light guiding plate 3, part of light rays that do not meet the total internal reflection condition pass through the transmission area 31 as they are to radiate to the outside. Furthermore, the light ray having passed through the transmission area 31 is diffused by the diffusion transmission member 21 to radiate to the display part 1 side. Moreover, in the transmission area 31, a light ray L3 which is the remaining part undergoes internal reflection, and the light ray L3 is incident on the display plane 41 of the electronic paper device 4 through the second internal reflection plane 3B of the light guiding plate 3. Herein, since the display plane 41 of the electronic paper device 4 is switched to the state of entire screen white display, the light ray L3 undergoes scattering reflection on the display plane 41. Herein, the light ray having undergone scattering reflection is incident again on the light guiding plate 3 through the second internal reflection plane 3B. Since the incident angle of the light ray does not meet the total internal reflection condition in the total internal reflection areas 32, the light ray radiates from the total internal reflection area 32 as well as from the transmission area 31 to the outside. Furthermore, the radiating light ray is diffused by the diffusion transmission member 21 and radiates to the display part 1 side. As a result, light rays radiate from the entirety of the first internal reflection plane 3A in the light guiding plate 3. Namely, the light guiding plate 3 functions as a planar light source similar to an ordinary backlight. Thereby, the two-dimensional display is performed similarly to a backlight method for which an ordinary backlight is disposed on the rear face side of the display part 1.

As described above, according to the display apparatus using the light source device according to the present embodiment, the total internal reflection areas 32 and transmission areas 31 are provided on the first internal reflection plane 3A of the light guiding plate 3, the diffusion transmission member 21 is provided on portions at least corresponding to the transmission areas 31, and light having passed through the transmission areas is diffused. Therefore, the light guiding plate 3 itself can function as a parallax bather equivalently. Thereby, the number of components and occupied space can be reduced compared with the display apparatus in the existing parallax barrier method. Moreover, readily switching between the two-dimensional display mode and three-dimensional display mode can be attained only by switching a display state of the electronic paper device 4.

### Second Embodiment

Next, a display apparatus according to a second embodiment of the present disclosure is described. In addition, constituents substantially same as ones in the above-mentioned display apparatus according to the first embodiment are designated by the same reference characters and the description is omitted properly.

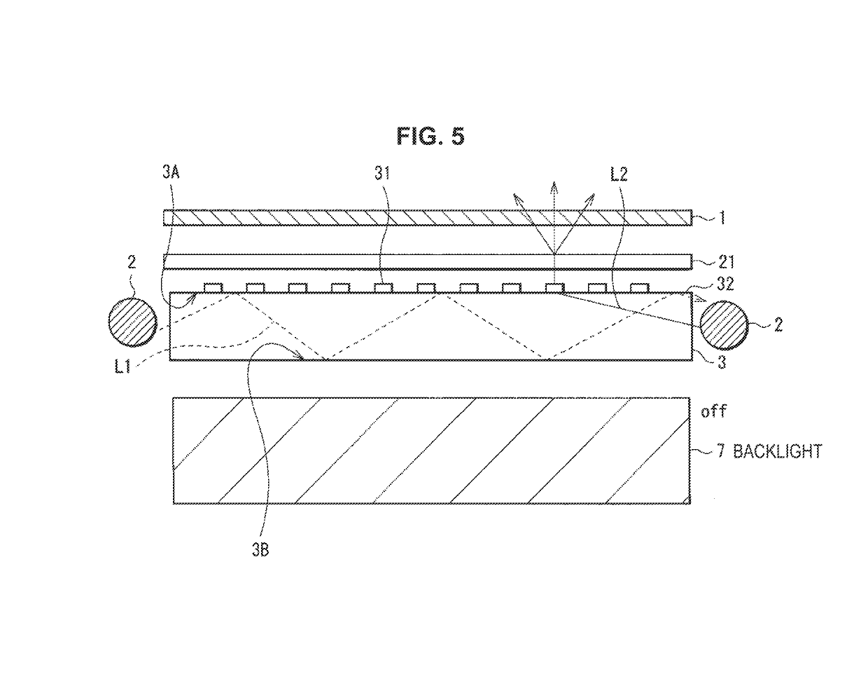

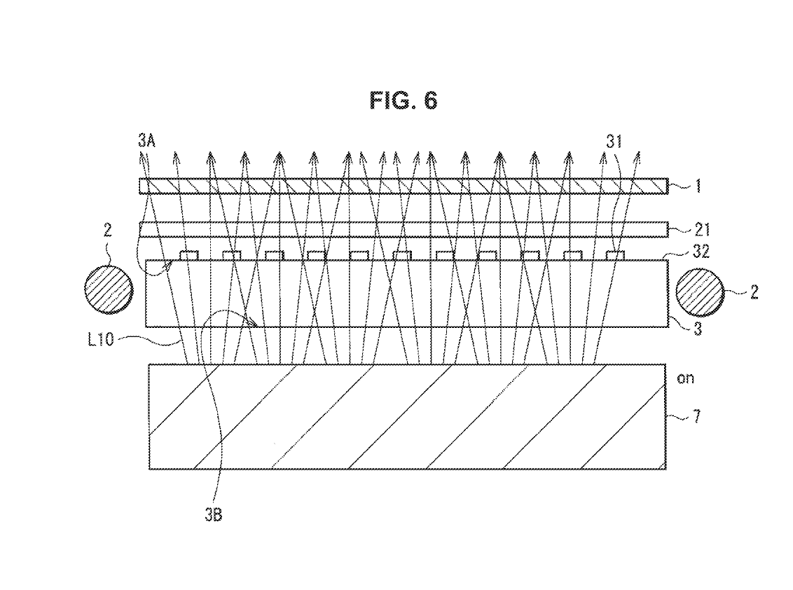

FIG. 5 and FIG. 6 illustrate one example of a configuration of the display apparatus according to the second embodiment of the present disclosure. This display apparatus is selectively switchable between a two-dimensional display mode and a three-dimensional display mode similarly to the display apparatus in FIG. 1 and FIG. 2. FIG. 5 corresponds to a configuration in the three-dimensional display mode. FIG. 6 corresponds to a configuration in the two-dimensional display mode. FIG. 5 and FIG. 6 also illustrate radiation of light rays from the light source device in the respective display mode.

In this display apparatus, the light source device includes a backlight 7 constituted of a planar light source in place of the electronic paper device 4 in the display apparatus in FIG. 1 and FIG. 2. Other constituents are same as the ones in FIG. 1 and FIG. 2. The backlight 7 is a second light source different from the light source 2 (first light source) disposed on the lateral side of the light guiding plate 3, and disposed opposite to the side on which the second internal reflection plane 3B is formed with respect to the light guiding plate 3. The backlight 7 irradiates the second internal reflection plane 3B from the outside with second illumination light L10. The backlight 7 undergoes ON (lighting)/OFF (non-lighting) control in response to switching between the two-dimensional display mode and three-dimensional display mode.

In this display apparatus, when performing display in the three-dimensional display mode (FIG. 5), the display part 1 performs image display based on three-dimensional image data, and the state of the backlight 7 is turned to an OFF (non-lit) state over the entire screen. The light source 2 disposed on the lateral side of the light guiding plate 3 is turned to an ON (lit) state. Under these conditions, a light ray (first illumination light) from the light source 2 undergoes total internal reflection repeatedly between the total internal reflection areas 32 of the first internal reflection plane 3A and the second internal reflection plane 3B in the light guiding plate 3, and thereby, is guided from one lateral side on which the light source 2 is disposed to the opposing other lateral side to radiate from the other lateral side. Meanwhile, out of light rays L2 incident on the transmission area 31 of the first internal reflection plane 3A in the light guiding plate 3, part of light rays that do not meet the total internal reflection condition pass through the transmission area 31 as they are to radiate to the outside. Furthermore, the light ray having passed through the transmission area 31 is diffused by the diffusion transmission member 21 to radiate to the display part 1 side. Moreover, in the transmission area 31, a light ray L3 which is the remaining part undergoes internal reflection, and the light ray radiates to the outside through the second internal reflection plane 3B of the light guiding plate 3 and does not participate with image display. As a result, light rays radiate only from the transmission areas 31 in the first internal reflection plane 3A of the light guiding plate 3. Namely, the surface of the light guiding plate 3 can function equivalently as a parallax barrier in which the transmission areas 31 are openings (slit parts) and the total internal reflection areas 32 are shielding parts. Thereby, the three-dimensional display is performed similarly to a parallax barrier method for which a parallax barrier is disposed on the rear face side of the display part 1.

On the other hand, when performing display in the two-dimensional display mode (FIG. 6), the display part 1 performs image display based on two-dimensional image data, and the state of the backlight 7 is turned to an ON (lit) state over the entire screen. The light source 2 disposed on the lateral side of the light guiding plate 3 is turned non-lit, for example. Under these conditions, a light ray from the backlight 7 (second illumination light L10) is incident on the light guiding plate 3 through the second internal reflection plane 3B substantially perpendicularly. Accordingly, since the incident angle of the light ray does not meet the total internal reflection condition in the total internal reflection areas 32, the light ray radiates from the total internal reflection area 32 as well as from the transmission area 31 to the outside. Furthermore, the radiating light ray is diffused by the diffusion transmission member 21 and radiates to the display part 1 side. As a result, light rays radiate from the entirety of the first internal reflection plane 3A in the light guiding plate 3. Namely, the light guiding plate 3 functions as a planar light source similar to an ordinary backlight. Thereby, the two-dimensional display is performed similarly to a backlight method for which an ordinary backlight is disposed on the rear face side of the display part 1.

In addition, when performing display in the two-dimensional display mode, the light source 2 disposed on the lateral side of the light guiding plate 3 may also be controlled to the ON (lit) state as well as the backlight 7. Moreover, when performing display in the two-dimensional display mode, the light source 2 may be switched between the non-lit state and lit state as necessary. Thereby, when only lighting the backlight 7 causes difference between the transmission areas 31 and total internal reflection areas 32 in brightness distribution, for example, the brightness distribution can be optimized over the entire screen by appropriately adjusting the lit state of the light source 2 (controlling ON/OFF or adjusting lighting quantity).

### Third Embodiment

Next, a display apparatus according to a third embodiment of the present disclosure is described. In addition, constituents substantially same as ones of the above-mentioned display apparatus according to the first or second embodiment are designated by the same reference characters and the description is omitted properly.

### [Entire Configuration of Display Apparatus]

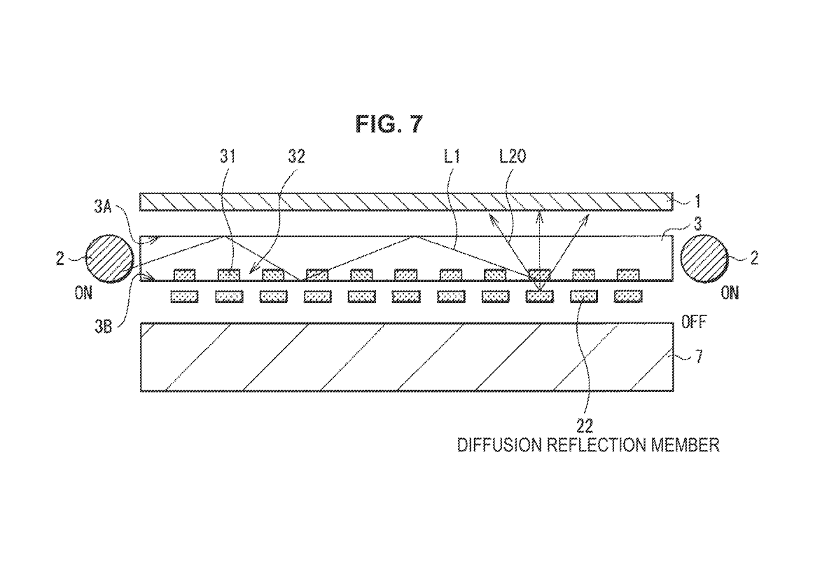

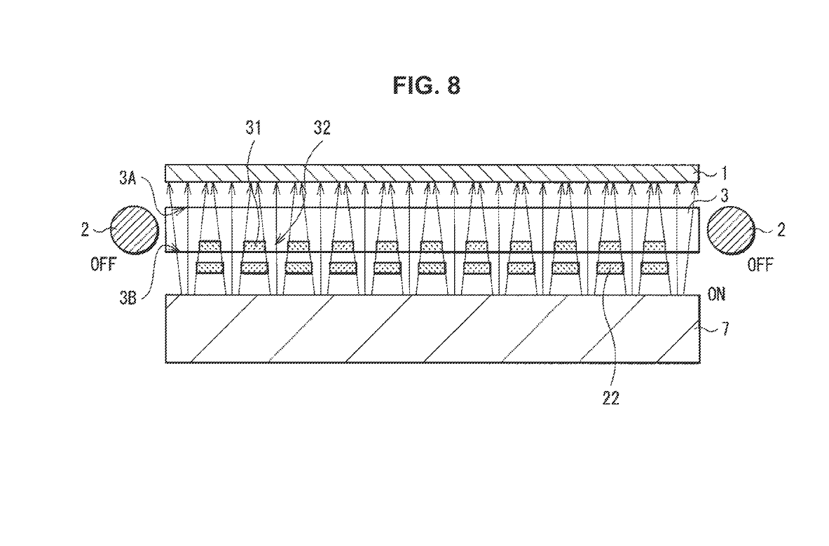

The above-mentioned first and second embodiments describe the exemplary configurations in which the transmission areas 31 and total internal reflection areas 32 are provided on the first internal reflection plane 3A side in the light guiding plate 3, whereas they may also be provided on the second internal reflection plane 3B side. For example, as illustrated in FIG. 7 and FIG. 8, the transmission areas 31 and total internal reflection areas 32 may be provided on the second internal reflection plane 3B side compared with the configuration of the above-mentioned second embodiment (FIG. 5 and FIG. 6). The display apparatus illustrated in FIG. 7 and FIG. 8 includes a diffusion reflection member 22 in place of the diffusion transmission member 21.

The display apparatus illustrated in FIG. 7 and FIG. 8 is selectively switchable between the two-dimensional display mode and three-dimensional display mode arbitrarily due to light source control similar to that of the display apparatus in FIG. 5 and FIG. 6. FIG. 7 schematically illustrates radiation of light rays from the light source device when turning only the light source 2 to the ON (lit) state, this corresponding to the three-dimensional display mode. FIG. 8 schematically illustrates radiation of light rays from the light source device when turning only the backlight 7 to the ON (lit) state, this corresponding to the two-dimensional display mode.

In this embodiment, the first internal reflection plane 3A of the light guiding plate 3 has undergone specular working over its entirety, allows a light ray incident by an incident angle that meets the total internal reflection condition inside the light guiding plate 3 to undergo total internal reflection, and allows a light ray that does not meet the total internal reflection condition to radiate to the outside.

The second internal reflection plane 3B includes the transmission areas 31 and the total internal reflection areas 32. The transmission areas 31 are formed by processing a surface shape of the light guiding plate 3 as described later, for example. In the second internal reflection plane 3B, the transmission areas 31 function as openings (slit parts) as a parallax barrier with respect to the first illumination light (light ray L1) from the light source 2 during the three-dimensional display mode, and the total internal reflection areas 32 function as shielding parts. In the second internal reflection plane 3B, the transmission areas 31 and total internal reflection areas 32 are provided in a pattern which corresponds to the structure of the parallax barrier. Namely, the total internal reflection areas 32 are provided in a pattern which corresponds to the shielding parts in the parallax barrier, and the transmission areas 31 are provided in a pattern which corresponds to the openings in the parallax barrier. In addition, the parallax barrier can employ various types of barrier patterns such as a stripe-shaped pattern in which a number of longitudinal slit-shaped openings are arranged parallelly in the horizontal direction while shielding pats intervene between them, for example, not being limited to specific one.

The first internal reflection plane 3A and the total internal reflection areas 32 in the second internal reflection plane 3B allow a light ray incident by the incident angle θ1 that meets the total internal reflection condition to undergo total internal reflection (allow a light ray incident by the incident angle θ1 greater than the predetermined critical angle α to undergo total internal reflection). Thereby, the first illumination light incident from the light source 2 by the incident angle θ1 that meets the total internal reflection condition is guided in the lateral side direction between the first internal reflection plane 3A and the total internal reflection areas 32 in the second internal reflection plane 3B due to total internal reflection. Moreover, the total internal reflection areas 32 transmit the second illumination light from the backlight 7, and emit it as light rays that do not meet the total internal reflection condition toward the first internal reflection plane 3A as illustrated in FIG. 8.

The transmission areas 31 transmit at least part of the first illumination light from the light source 2 (light rays L1) as it is, and emit it as light rays that do not meet the total internal reflection condition to the outside (diffusion reflection member 22 side) as illustrated in FIG. 7. The diffusion reflection member 22 is provided on portions corresponding to the transmission areas 31, diffuses the light having passed through the transmission areas 31, and reflects the diffused light toward the second internal reflection plane 3B.

### [Specific Example of Configuration of Transmission Areas 31]

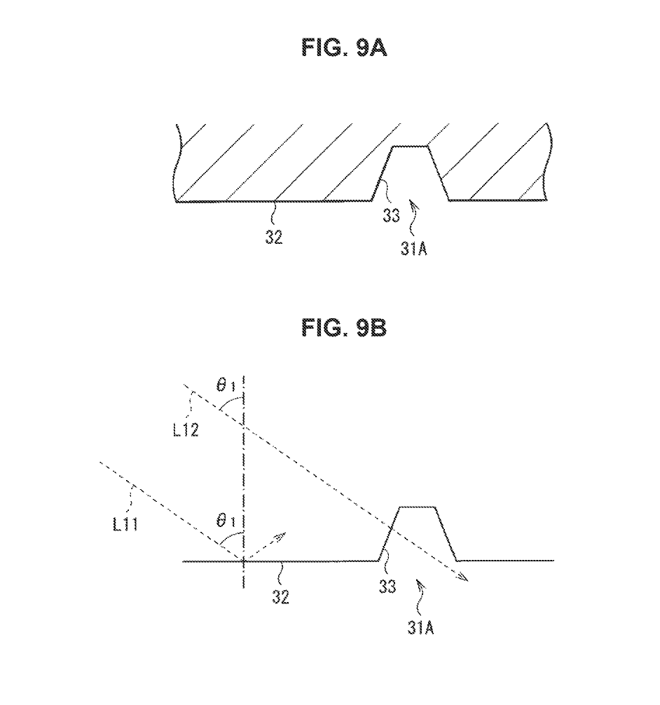

FIG. 9A illustrates a first exemplary configuration of the second internal reflection plane 3B in the light guiding plate 3. FIG. 9B schematically illustrates reflection and transmission of light rays on the second internal reflection plane 3B in the first exemplary configuration illustrated in FIG. 9A. This first exemplary configuration is an exemplary configuration in which the transmission area 31 is formed into a transmission area 31A with a concave shape with respect to the total internal reflection areas 32. The transmission area 31A with such a concave shape can be formed by performing specular working on the surface of the light guiding plate 3, and after that, performing laser machining on the portion corresponding to the transmission area 31A, for example. In case of the first exemplary configuration, the first illumination light L11 incident from the light source 2 by the incident angle θ1 that meets the total internal reflection condition undergoes total internal reflection on the total internal reflection area 32 in the second internal reflection plane 3B. On the other hand, in the transmission area 31A with the concave shape, even when being incident by the incident angle θ1 same as in the total internal reflection area 32, at least part of light rays of the incident first illumination light L12 do not meet the total internal reflection condition in the lateral part 33 of the concave shape, and pass as they are. The light thus having passed is diffused by the diffusion reflection member 22, is reflected toward the second internal reflection plane 3B, and passes again mainly through the transmission area 31 as returning light as illustrated in FIG. 7. Part or all of the light rays (scattered light L20) which have undergone scattering reflection toward this internal reflection plane 3B radiate as light rays that do not meet the total internal reflection condition toward the first internal reflection plane 3A.

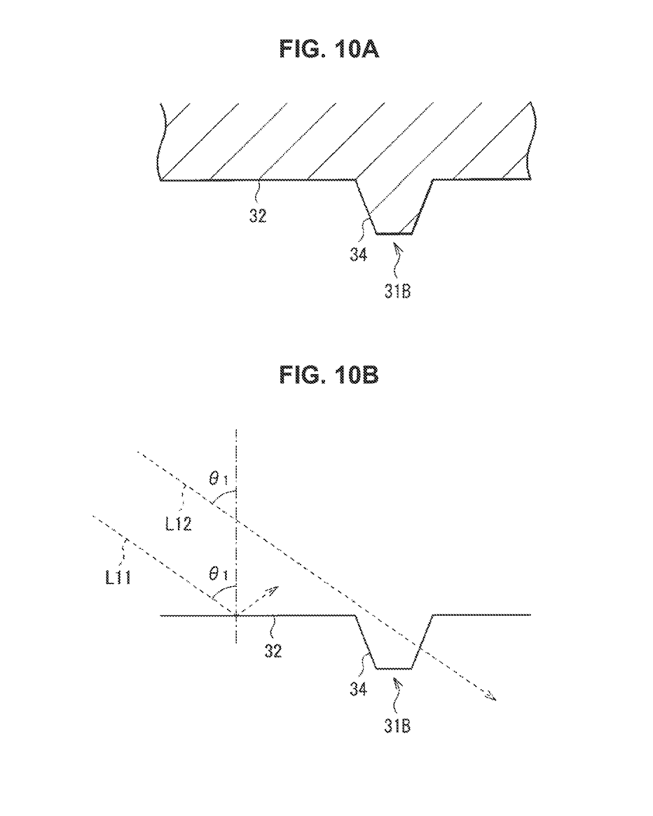

FIG. 10A illustrates a second exemplary configuration of the second internal reflection plane 3B in the light guiding plate 3. FIG. 10B schematically illustrates reflection and transmission of light rays on the second internal reflection plane 3B in the second exemplary configuration illustrated in FIG. 10A. This second exemplary configuration is an exemplary configuration in which the transmission area 31 is formed into a transmission area 31B with a convex shape with respect to the total internal reflection areas 32. The transmission area 31B with such a convex shape can be formed by molding the surface of the light guiding plate 3 using a die, for example. In this case, portions corresponding to the total internal reflection areas 32 undergo specular working with the surface of the die. In case of the second exemplary configuration, the first illumination light L11 incident from the light source 2 by the incident angle θ1 that meets the total internal reflection condition undergoes total internal reflection on the total internal reflection areas 32 in the second internal reflection plane 3B. On the other hand, in the transmission area 31B with the convex shape, even when being incident by the incident angle θ1 same as in the total internal reflection area 32, at least part of light rays of the incident first illumination light L12 do not meet the total internal reflection condition in the lateral part 34 of the convex shape, and pass as they are. The light thus having passed is diffused by the diffusion reflection member 22, is reflected toward the second internal reflection plane 3B, and passes again mainly through the transmission area 31 as returning light as illustrated in FIG. 7. Part or all of the light rays (scattered light L20) which have undergone scattering reflection toward this internal reflection plane 3B radiate as light rays that do not meet the total internal reflection condition toward the first internal reflection plane 3A.

### [Operation of Display Apparatus]

When performing display in the three-dimensional display mode for this display apparatus, the display part 1 performs image display based on three-dimensional image data, and the light source 2 and backlight 7 undergo ON (lighting)/OFF (non-lighting) control for the three-dimensional display. Specifically, the light source 2 is turned to the ON (lit) state, and the backlight 7 is turned to the OFF (non-lit) state due to the control as illustrated in FIG. 7. Under these conditions, the first illumination light (light ray L1) from the light source 2 undergoes total internal reflection repeatedly between the first internal reflection plane 3A and the total internal reflection areas 32 of the second internal reflection plane 3B in the light guiding plate 3, and thereby, is guided from one lateral side on which the light source 2 is disposed to the opposing other lateral side to radiate from the other lateral side. Meanwhile, part of the first illumination light from the light source 2 passes through the transmission areas 31 of the light guiding plate 3 as it is. The light having passed is diffused by the diffusion reflection member 22, is reflected toward the second internal reflection plane 3B, and passes again mainly through the transmission areas 31 as returning light. Part or all of the light rays (scattered light L20) which have undergone scattering reflection toward this internal reflection plane 3B radiate as light rays that do not meet the total internal reflection condition toward the first internal reflection plane 3A, and passes through the first internal reflection plane 3A to radiate to the outside of the light guiding plate 3. Thereby, the light guiding plate itself can function as a parallax barrier, that is, can function equivalently as a parallax barrier in which the transmission areas 31 are openings (slit parts) and the total internal reflection areas 32 are shielding parts with respect to the first illumination light from the light source 2. Thereby, the three-dimensional display is performed similarly to a parallax barrier method for which a parallax barrier is disposed on the rear face side of the display part 1.

On the other hand, when performing display in the two-dimensional display mode, the display part 1 performs image display based on two-dimensional image data, and the light source 2 and backlight 7 undergo ON (lighting)/OFF (non-lighting) control for the two-dimensional display. Specifically, the light source 2 is turned to the OFF (non-lit) state, and the backlight 7 is turned to the ON (lit) state as illustrated in FIG. 8, for example. Under these conditions, the second illumination light from the backlight 7 passes through the total internal reflection areas 32 in the second internal reflection plane 3B, and thereby, radiates from most of the entirety of the first internal reflection plane 3A as light rays that do not meet the total internal reflection condition to the outside of the light guiding plate 3. Namely, the light guiding plate 3 functions as a planar light source similar to an ordinary backlight. Thereby, the two-dimensional display is performed similarly to a backlight method for which an ordinary backlight is disposed on the rear face side of the display part 1.

In addition, the second illumination light radiates from most of the entirety of the light guiding plate 3 even when only the backlight 7 is turned on, whereas the light source 2 may also be turned on as necessary. Thereby, when only lighting the backlight 7 causes difference between portions corresponding to the transmission areas 31 and total internal reflection areas 32 in brightness distribution, for example, the brightness distribution can be optimized over the entire screen by appropriately adjusting the lit state of the light source 2 (controlling ON/OFF or adjusting lighting quantity). However, when performing the two-dimensional display, in case of the display part 1 side being capable of sufficiently correcting the brightness, for example, only lighting the backlight 7 is enough.

As described above, according to the display apparatus using the light source device according to the present embodiment, the transmission areas 31 and total internal reflection areas 32 are provided on the second internal reflection plane 3B of the light guiding plate 3, the diffusion reflection member 22 is provided on portions corresponding to the transmission areas 31, and the first illumination light from the light source 2 and the second illumination light from the backlight 7 can radiate selectively to the outside of the light guiding plate 3. Therefore, the light guiding plate 3 itself can function as a parallax barrier equivalently.

### Other Embodiments

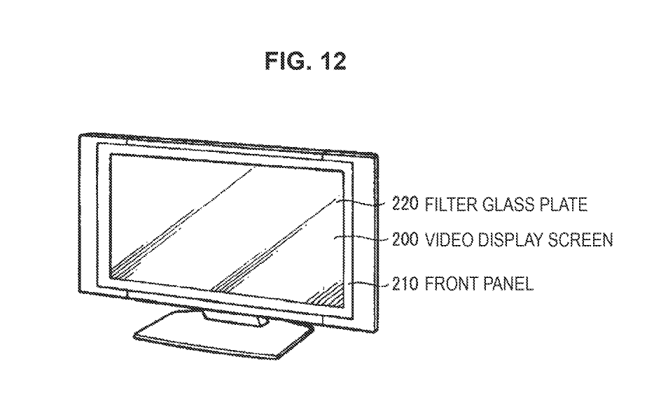

Embodiments according to the present disclosure are not limited to the above-mentioned embodiments, but various modifications may occur. For example, the display apparatus according to each of the above-mentioned embodiments can be applied to various kinds of electronic equipment having a display function FIG. 12 illustrates an appearance configuration of a television apparatus as one example of such electronic equipment. The television apparatus includes a video display screen 200 having a front panel 210 and a filter glass plate 220.

The present technology may also be configured as below, for example.

(1) A light source device including:

a light guiding plate including a first internal reflection plane and a second internal reflection plane opposite to each other;

a first light source irradiating an inside of the light guiding plate with first illumination light from its lateral side; and

a diffusion member disposed opposite to the first internal reflection plane or the second internal reflection plane and diffusing incident light, wherein

a plurality of transmission areas permitting the first illumination light to pass and to radiate toward an outside of the light guiding plate are provided on the first internal reflection plane or the second internal reflection plane, and

the diffusion member is disposed opposite to the plurality of transmission areas and diffuses light having passed through the plurality of transmission areas.

(2) The light source device according to (1), wherein

the plurality of transmission areas are provided on the first internal reflection plane, and

the diffusion member diffuses and transmits light having passed through the plurality of transmission areas.

(3) The light source device according to (1), wherein

the plurality of transmission areas are provided on the second internal reflection plane, and

the diffusion member diffuses light having passed through the plurality of transmission areas and reflects it toward the second internal reflection plane.

(4) The light source device according to any one of (1) to (3), wherein

a total internal reflection area permitting the first illumination light to undergo total internal reflection is provided in a portion except the plurality of transmission areas within the first internal reflection plane or the second internal reflection plane.

(5) The light source device according to (4), wherein

the transmission area is formed by processing a surface of the light guiding plate corresponding to the first internal reflection plane or the second internal reflection plane into a shape different from that of the total internal reflection area.

(6) The light source device according to (1), (2), (4), or (5), further including

an optical device disposed over a side where the second internal reflection plane is formed, opposite to the light guiding plate, and being selectively switchable of action with respect to an incident light ray between two states of a scattering reflection state and a light absorption state.

(7) The light source device according to any one of (1) to (5), further including

a second light source disposed over a side where the second internal reflection plane is formed, opposite to the light guiding plate, and irradiating the second internal reflection plane with second illumination light from its outside.

(8) A display apparatus including:

a display part performing image display; and

a light source device emitting light for image display toward the display part, wherein

the light source device includes

a light guiding plate including a first internal reflection plane and a second internal reflection plane opposite to each other;

a first light source irradiating an inside of the light guiding plate with first illumination light from its lateral side; and

a diffusion member disposed opposite to the first internal reflection plane or the second internal reflection plane and diffusing incident light, wherein

a plurality of transmission areas permitting the first illumination light to pass and to radiate toward an outside of the light guiding plate are provided on the first internal reflection plane or the second internal reflection plane, and

the diffusion member is disposed opposite to the plurality of transmission areas and diffuses light having passed through the plurality of transmission areas.

(9) The display apparatus according to (8), further including

an optical device disposed over a side where the second internal reflection plane is formed, opposite to the light guiding plate, and being selectively switchable of action with respect to an incident light ray between two states of a light absorption state and a scattering reflection state, wherein

the display part selectively switches, and displays, a plurality of viewpoint images based on three-dimensional image data and an image based on two-dimensional image data, and

the optical device switches action with respect to an incident light ray to a light absorption state when displaying the plurality of viewpoint images on the display part, and switches action with respect to an incident light ray to a scattering reflection state when displaying an image based on two-dimensional image data on the display part.

(10) The display apparatus according to (8), further including

a second light source disposed over a side where the second internal reflection plane is formed, opposite to the light guiding plate, and irradiating the second internal reflection plane with second illumination light from its outside, wherein

the display part selectively switches, and displays, a plurality of viewpoint images based on three-dimensional image data and an image based on two-dimensional image data, and

the second light source is controlled to a non-lit state when displaying the plurality of viewpoint images on the display part, and is controlled to a lit state when displaying an image based on the two-dimensional image data on the display part.

(11) The display apparatus according to (10), wherein

the first light source is controlled to a lit state when displaying the plurality of viewpoint images on the display part, and is controlled to a non-lit state or a lit state when displaying an image based on the two-dimensional image data on the display part.

(12) Electronic equipment including

a display apparatus, wherein

the display apparatus includes

a display part performing image display; and

a light source device emitting light for image display toward the display part, wherein

the light source device includes

a light guiding plate including a first internal reflection plane and a second internal reflection plane opposite to each other;

a first light source irradiating an inside of the light guiding plate with first illumination light from its lateral side; and

a diffusion member disposed opposite to the first internal reflection plane or the second internal reflection plane and diffusing incident light, wherein

a plurality of transmission areas permitting the first illumination light to pass and to radiate toward an outside of the light guiding plate are provided on the first internal reflection plane or the second internal reflection plane, and

the diffusion member is disposed opposite to the plurality of transmission areas and diffuses light having passed through the plurality of transmission areas.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-214871 filed in the Japan Patent Office on Sep. 29, 2011, the entire content of which is hereby incorporated by reference.

What is claimed is:

1. A light source device comprising:
a light guiding plate including a first internal reflection plane and a second internal reflection plane opposite to each other;
a first light source irradiating an inside of the light guiding plate with first illumination light from its lateral side; and
a diffusion member disposed opposite to the first internal reflection plane or the second internal reflection plane and diffusing incident light, wherein
a plurality of transmission areas permitting the first illumination light to pass and to radiate toward an outside of the light guiding plate are provided on the first internal reflection plane or the second internal reflection plane, and
the diffusion member is disposed opposite to the plurality of transmission areas and diffuses light having passed through the plurality of transmission areas.

2. The light source device according to claim 1, wherein
the plurality of transmission areas are provided on the first internal reflection plane, and
the diffusion member diffuses and transmits light having passed through the plurality of transmission areas.

3. The light source device according to claim 1, wherein
the plurality of transmission areas are provided on the second internal reflection plane, and
the diffusion member diffuses light having passed through the plurality of transmission areas and reflects it toward the second internal reflection plane.

4. The light source device according to claim 1, wherein
a total internal reflection area permitting the first illumination light to undergo total internal reflection is provided in a portion except the plurality of transmission areas within the first internal reflection plane or the second internal reflection plane.

5. The light source device according to claim 4, wherein
the transmission area is formed by processing a surface of the light guiding plate corresponding to the first internal reflection plane or the second internal reflection plane into a shape different from that of the total internal reflection area.

6. The light source device according to claim 1, further comprising
an optical device disposed over a side where the second internal reflection plane is formed, opposite to the light guiding plate, and being selectively switchable of action with respect to an incident light ray between two states of a scattering reflection state and a light absorption state.

7. The light source device according to claim 1, further comprising
a second light source disposed over a side where the second internal reflection plane is formed, opposite to the light guiding plate, and irradiating the second internal reflection plane with second illumination light from its outside.

8. A display apparatus comprising:
a display part performing image display; and
a light source device emitting light for image display toward the display part, wherein
the light source device includes
a light guiding plate including a first internal reflection plane and a second internal reflection plane opposite to each other;
a first light source irradiating an inside of the light guiding plate with first illumination light from its lateral side; and
a diffusion member disposed opposite to the first internal reflection plane or the second internal reflection plane and diffusing incident light, wherein
a plurality of transmission areas permitting the first illumination light to pass and to radiate toward an outside of the light guiding plate are provided on the first internal reflection plane or the second internal reflection plane, and
the diffusion member is disposed opposite to the plurality of transmission areas and diffuses light having passed through the plurality of transmission areas.

9. The display apparatus according to claim 8, further comprising
an optical device disposed over a side where the second internal reflection plane is formed, opposite to the light guiding plate, and being selectively switchable of action with respect to an incident light ray between two states of a light absorption state and a scattering reflection state, wherein
the display part selectively switches, and displays, a plurality of viewpoint images based on three-dimensional image data and an image based on two-dimensional image data, and
the optical device switches action with respect to an incident light ray to a light absorption state when displaying the plurality of viewpoint images on the display part, and switches action with respect to an incident light ray to a scattering reflection state when displaying an image based on two-dimensional image data on the display part.

10. The display apparatus according to claim 8, further comprising
a second light source disposed over a side where the second internal reflection plane is formed, opposite to the light guiding plate, and irradiating the second internal reflection plane with second illumination light from its outside, wherein
the display part selectively switches, and displays, a plurality of viewpoint images based on three-dimensional image data and an image based on two-dimensional image data, and
the second light source is controlled to a non-lit state when displaying the plurality of viewpoint images on the display part, and is controlled to a lit state when displaying an image based on the two-dimensional image data on the display part.

11. The display apparatus according to claim 10, wherein
the first light source is controlled to a lit state when displaying the plurality of viewpoint images on the display part, and is controlled to a non-lit state or a lit state when displaying an image based on the two-dimensional image data on the display part.

12. Electronic equipment comprising
a display apparatus, wherein
the display apparatus includes
a display part performing image display; and
a light source device emitting light for image display toward the display part, wherein
the light source device includes
a light guiding plate including a first internal reflection plane and a second internal reflection plane opposite to each other;
a first light source irradiating an inside of the light guiding plate with first illumination light from its lateral side; and
a diffusion member disposed opposite to the first internal reflection plane or the second internal reflection plane and diffusing incident light, wherein
a plurality of transmission areas permitting the first illumination light to pass and to radiate toward an outside of the light guiding plate are provided on the first internal reflection plane or the second internal reflection plane, and
the diffusion member is disposed opposite to the plurality of transmission areas and diffuses light having passed through the plurality of transmission areas.
